(19) United States
(12) Patent Application Publication
(10) Pub. No.: US 2026/0291630 A1
(43) Pub. Date: Sep. 24, 2026

(54) INTERFERENCE MEASUREMENT FOR SUBBAND NON-OVERLAPPED FULL DUPLEX &DYNAMIC TIME DIVISION DUPLEXING

(71) Applicant: Nokia Technologies Oy, Espoo (FI)

(72) Inventors: Jingyuan SUN, Beijing (CN); Nhat-Quang NHAN, Reims (FR); Youngsoo YUK, Seoul (KR); Jie GAO, Hangzhou, Zhejiang (CN); Claudio ROSA, Randers NV (DK); Erika PORTELA LOPES DE ALMEIDA, Aalborg (DK); Roberto MALDONADO, Aalborg (DK)

(21) Appl. No.: 19/475,007

(22) PCT Filed: Apr. 17, 2023
(86) PCT No.: PCT/CN2023/088757

§ 371 Date: Oct. 13, 2025

(51) Int. Cl. H04B 17/345; H04B 7/06; H04L 5/00

(52) U.S. Cl. CPC H04B 17/345; H04B 7/0626; H04L 5/005

(57) ABSTRACT

Embodiments of the present disclosure relate to devices, methods, apparatuses and computer readable storage media of interference measurement for subband non-overlapping full duplex (SBFD) and/or dynamic time division duplexing (TDD). The method comprises receiving, from a second apparatus, a first indication at least indicating one or more CSI-IM resources, each of the one or more channel state information interference measurement (CSI-IM) resources being mappable to at least one sounding reference signal (SRS) resource pattern; and performing, based on the first indication, at least one interference measurement associated with the one or more CSI-IM resources.

### FIELD

Embodiments of the present disclosure generally relate to the field of telecommunication and in particular to devices, methods, apparatuses and computer readable storage media of interference measurement for subband non-overlapping full duplex (SBFD) and/or dynamic time division duplexing (TDD).

### BACKGROUND

3rd Generation Partnership Project (3GPP) 5th Generation Mobile Communication Technology (5G) New Radio (NR) currently supports two duplexing modes, namely Frequency Division Duplexing (FDD) for paired bands and TDD for unpaired bands. In TDD, the time domain resource may be split between downlink and uplink. Allocation of a limited time duration for the uplink in TDD may result in reduced coverage, increased latency, and reduced capacity. Therefore, a study of subband non-overlapping full duplex (SBFD) is initiated in the release 18.

### SUMMARY

In a first aspect, there is provided a first apparatus. The first apparatus comprises at least one processor; and at least one memory storing instructions that, when executed by the at least one processor, cause the first apparatus at least to: receive, from a second apparatus, a first indication at least indicating one or more channel state information interference measurement (CSI-IM) resources, each of the one or more CSI-IM resources being mappable to at least one sounding reference signal (SRS) resource pattern; and perform, based on the first indication, at least one interference measurement associated with the one or more CSI-IM resources.

In a second aspect, there is provided a second apparatus. The second apparatus comprises at least one processor; and at least one memory storing instructions that, when executed by the at least one processor, cause the second apparatus at least to: determine a first indication at least indicating one or more CSI-IM resources, each of the one or more CSI-IM resources being mappable to SRS resource pattern; and transmit the first indication to a first apparatus.

In a third aspect, there is provided a method. The method comprises receiving, from a second apparatus, a first indication at least indicating one or more CSI-IM resources, each of the one or more CSI-IM resources being mappable to at least one SRS resource pattern; and performing, based on the first indication, at least one interference measurement associated with the one or more CSI-IM resources.

In a fourth aspect, there is provided a method. The method comprises determining, at a second apparatus, a first indication at least indicating one or more CSI-IM resources, each of the one or more CSI-IM resources being mappable to at least one SRS resource pattern; and transmitting the first indication to a first apparatus.

In a fifth aspect, there is provided a first apparatus comprising means for receiving, from a second apparatus, a first indication at least indicating one or more CSI-IM resources, each of the one or more CSI-IM resources being mappable to at least one SRS resource pattern; means for performing, based on the first indication, at least one interference measurement associated with the one or more CSI-IM resources; and means for transmitting, to the second apparatus, a CSI report at least including a measurement result for the CLI.

In a sixth aspect, there is provided a second apparatus comprising means for determining a first indication at least indicating one or more CSI-IM resources, each of the one or more CSI-IM resources being mappable to at least one SRS resource pattern; and means for transmitting the first indication to a first apparatus.

In a seventh aspect, there is provided a computer readable medium having a computer program stored thereon which, when executed by at least one processor of an apparatus, causes the apparatus to carry out the method according to the third aspect or the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings.

FIG. 1 illustrates an example environment in which example embodiments of the present disclosure may be implemented;

FIG. 2 shows an example of SBFD and non-SBFD slots according to some example embodiments of the present disclosure;

FIG. 3 shows a signaling chart illustrating an example of process according to some example embodiments of the present disclosure;

FIG. 4 shows an example of a CSI-IM resource associated with SBFD mapped on SRS resource element (RE) pattern according to some example embodiments of the present disclosure;

FIG. 5 shows a flowchart of an example method of interference measurement for SBFD and/or dynamic TDD according to some example embodiments of the present disclosure;

FIG. 6 shows a flowchart of an example method of interference measurement for SBFD and/or dynamic TDD according to some example embodiments of the present disclosure;

FIG. 7 shows a simplified block diagram of a device that is suitable for implementing example embodiments of the present disclosure; and

FIG. 8 shows a block diagram of an example computer readable medium in accordance with some embodiments of the present disclosure.

Throughout the drawings, the same or similar reference numerals may represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein may have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT), an Enhanced Machine type communication (eMTC) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the terms “network device”, “radio network device” and/or “radio access network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, low earth orbit (RAN) split architecture includes a Centralized Unit (CU) and a Distributed Unit (DU). In some other example embodiments, part of the radio access network device or full of the radio access network device may embarked on an airborne or space-borne NTN vehicle.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

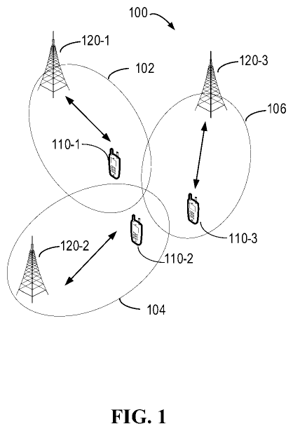

FIG. 1 shows an example communication network 100 in which embodiments of the present disclosure may be implemented. As shown in FIG. 1, the communication network 100 may include a terminal device 110-1, a terminal device 110-2, and a terminal device 110-3. Hereinafter the terminal device 110-1, 110-2, 110-3 may also be referred to as a UE or a first apparatus collectively.

The communication network 100 may further include a network device 120-1 providing a cell 102, a network device 120-2 providing a cell 104 and a network device 120-3 providing a cell 106. Hereinafter the network device 120 may also be referred to as a gNB or a second apparatus collectively. The terminal device 110-1 may communicate with the network device 120-1 within the coverage of the cell 102. In a similar way, the terminal device 110-2 may communicate with the network device 120-2 within the coverage of the cell 104, and the terminal device 110-3 may communicate with the network device 120-3 within the coverage of the cell 106. In this scenario, the cell 102 may be considered as a serving cell of the terminal device 110-1, and the cell 104 and cell 106 may be considered as neighbor cell of the terminal device 110-1.

It is to be understood that the number of network devices and terminal devices shown in FIG. 1 is given for the purpose of illustration without suggesting any limitations. The communication network 100 may include any suitable number of network devices and terminal devices.

In some example embodiments, links from the network device 120-1, 120-2 or 120-3 to the terminal device 110-1, 110-2, or 110-3 may be referred to as a downlink (DL), while links from the terminal device 110-1, 110-2, or 110-3 to the network device 120-1, 120-2 or 120-3 may be referred to as an uplink (UL). In DL, the network device 120-1, 120-2 or 120-3 is a transmitting (TX) device (or a transmitter) and the terminal device 110-1, 110-2, or 110-3 is a receiving (RX) device (or receiver). In UL, the terminal device 110-1, 110-2, or 110-3 is a TX device (or transmitter) and the network device 120 is a RX device (or a receiver).

Communications in the communication environment 100 may be implemented according to any proper communication protocol(s), includes, but not limited to, cellular communication protocols of the first generation (1G), the second generation (2G), the third generation (3G), the fourth generation (4G), 5G, the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, includes but not limited to: Code Division Multiple Access (CDMA), Frequency Division Multiple Access (FDMA), Time Division Multiple Access (TDMA), FDD, TDD, Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

The current two duplexing modes in 3GPP 5G NR are facing challenges that allocating the limited time duration in the duplexing modes can result in reduced capabilities. To address this challenge, 3GPP has agreed to initiate a release 18 study item on the evolution of duplexing operations in NR. One of the objectives of the study item is to allow simultaneous DL and UL transmission on different physical resource blocks (PRBs)/subbands within an unpaired wideband NR cell. In the present disclosure, this duplexing scheme is referred to as SBFD. In other sources, this duplexing scheme is also referred to as cross-division duplexing (xDD) scheme or Flexible Duplexing (FDU).

In this study, it is assumed that duplex enhancement happens at the gNB side, half duplex operation happens at the UE side, and no restrictions on frequency ranges.

The detailed objectives include studying the subband non-overlapping full duplex and potential enhancements on dynamic/flexible TDD, specifically, as follows:
identifying possible schemes and evaluating their feasibility and performances;
studying inter-gNB and inter-UE cross link interference (CLI) handling and identifying solutions to manage them;
considering intra-subband CLI and inter-subband CLI in case of the subband non-overlapping full duplex;
studying the performance of the identified schemes as well as the impact on legacy operations assuming their co-existence in co-channel and adjacent channels;
studying the feasibility of an impact on RF requirements considering adjacent-channel co-existence with the legacy operation;
studying the feasibility of an impact on RF requirements considering the self-interference, the inter-subband CLI, and the inter-operator CLI at gNB and the inter-subband CLI and inter-operator CLI at UE.

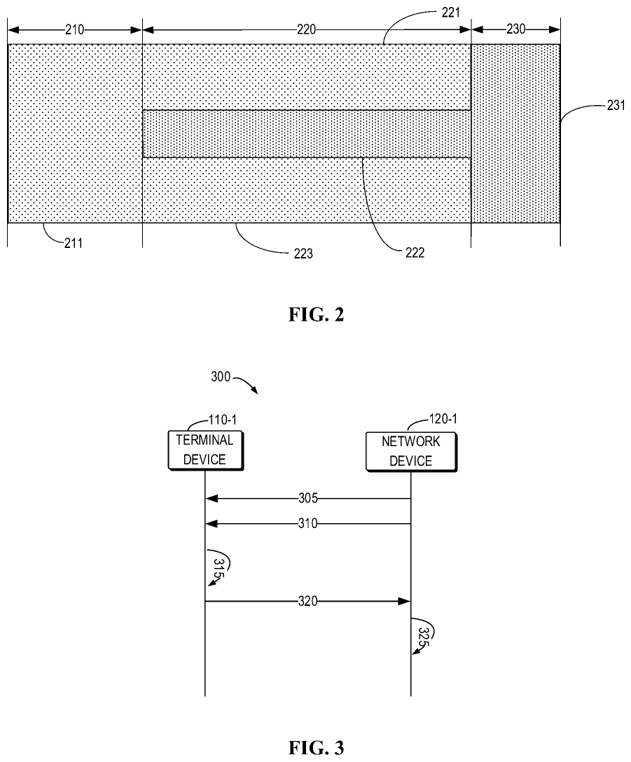

FIG. 2 shows an example of SBFD and non-SBFD slots according to some example embodiments of the present disclosure. As shown in FIG. 2, there are two slot types exist for both DL and UL transmissions, including SBFD slots 220 and non-SBFD slots 210 and 230. During the SBFD slots 220, both the non-overlapping DL subbands 221 and 223 and UL subband(s) 222 exist, while during the non-SBFD slots 210 and 230, the entire band is used for DL resource 211 or UL resource 231 (i.e., full DL/UL slots).

Several SBFD operation modes have been studied including whether the time and frequency locations of subbands for SBFD operation are known to the SBFD-aware UE or not. It however has been agreed in 3GPP that at least the operation mode with time and frequency locations of subbands for SBFD operation being known to the SBFD-aware UE is prioritized. This means that SBFD slots should be known by the (SBFD-aware) UE in one way or another.

For SBFD, there were only discussions on an option that the DL may be outside of the DL subband e.g., when the entire symbol is changed to DL-only based on the requirement of the traffic status. In this case, there may be different transmission directions on multiple cells based on different traffic in the cells.

In some embodiments, for dynamic SBFD, specifically for SBFD-aware UEs, further study whether DL receptions outside semi-statically configured DL subband(s) are allowed or not in a symbol configured as DL in TDD-UL-DL-ConfigCommon based on the following options:
Option 1 (semi-static): DL receptions outside semi-statically configured DL subband(s) are not allowed;
Option 2: DL receptions outside semi-statically configured DL subband(s) are allowed.

In some embodiments, for SBFD-aware UEs, further study whether DL receptions outside semi-statically configured DL subband(s) and UL transmissions outside semi-statically configured UL subband are allowed or not in the symbol configured as flexible in TDD-UL-DL-ConfigCommon based on the following options:
Option 1 (semi-static): DL receptions outside semi-statically configured DL subband(s) are not allowed and UL transmissions outside semi-statically configured UL subband are not allowed;
Option 2: DL receptions outside semi-statically configured DL subband(s) are allowed, and UL transmissions outside the semi-statically configured UL subbands are not allowed;
Option 3: DL receptions outside semi-statically configured DL subband(s) are allowed, and UL transmissions outside the semi-statically configured UL subbands are allowed.

Dynamic SBFD should be compared with dynamic TDD and/or semi-static SBFD in terms of performance, implementation complexity, and switching latency. Additionally, for each option, additional conditions may apply to determine whether the option is applicable.

In some embodiments, for the CSI measurement, there are also some discussions to study the inter-UE inter-subband CLI measurement. Specifically, for inter-UE inter-subband CLI measurement, study at least the following methods:
Method #1: victim UE measures Received Signal Strength Indicator (RSSI) within DL subband;
Method #2: victim UE measures Reference signal receive power (RSRP) of aggressor UE within UL subband;

Method #3: victim UE measures RSSI within UL subband.

It is to be noted that the restriction in release 16 that CLI is only measured within DL Bandwidth Part (BWP) does not forbid UE to measure CLI in UL subband when UL subband is confined within DL BWP.

For CSI measurement and report, the discussion is very basic to discuss the CSI-RS measurement for channel and how to report the CSI, separate or same for a different type of symbols, i.e., SBFD or non-SBFD symbols.

In some embodiments, study the frequency resource allocation for CSI-RS across downlink subbands for SBFD-aware UEs considering the following options:
Option 1: Two contiguous CSI-RS resources that are linked;
Option 2: One CSI-RS resource;
   Option 2-1: Non-contiguous CSI-RS resource allocation;
   Option 2-2: One contiguous CSI-RS resource allocation with non-contiguous CSI-RS resource derived by excluding frequency resources outside DL subband(s).

In some embodiments, for SBFD-aware UEs, study the following options for CSI report associated with periodic/semi-persistent CSI-RS, at least, across SBFD symbols and non-SBFD symbols in different slots (each CSI-RS resources within a slot has either all SBFD or all non-SBFD symbols):
Option 1: separate CSI reporting for SBFD symbols and non-SBFD symbols;
Option 2: same CSI reporting for SBFD symbols and non-SBFD symbols.

As mentioned above, there may be different SBFD subband or different transmission directions on the same PRBs in multiple cells because of different traffic statuses in the cells. Then in one cell when it is DL subband in some slot(s), there may be UL SBFD subband in neighbor cell(s).

In some embodiments, CLI-RSRP measurement or CLI-RSSI measurement can be used to identify the possible CLI interference strength. But to achieve the exact CSI on DL subband with inter-subband interference, recalculation of the CSI is needed based on UE's reported CSI with/without non-experienced CLI and the CLI-RSRP/CLI-RSSI, and this recalculation is not accurate in power and spatial domain.

Moreover, inter-cell UE may cause different CLI (e.g., inter-cell co-channel UE-UE CLI) because of the different distances between the interfering UE and victim UE. For example, as shown in FIG. 1, a DL transmission from the network device 120-1 to the terminal device 110-1 (the victim UE) may be interfered by an UL transmission from the terminal device 110-2 to the network device (the interfering UE) 120-2 and/or the terminal device 110-3 (the interfering UE) to the network device 120-3.

As currently, no scheme to guarantee whether CLI and what CLI has been included in the CSI-IM related measurement, and the CLI included in CSI measurement/report may include mixed CLI from different UE's UL transmission, which will not reflect the exact CLI interference to UE's PDSCH from exact UE's UL transmission in a neighbor cell in the PDSCH scheduling, resulting an invalid CSI measurement/report and no help in scheduling. Even with recalculation, gNB cannot recalculate as gNB does not even know what CLI is included in the CSI measurement. Therefore, the present disclosure will provide a solution for accurate CSI measurement reflecting the CLI from a neighbor cell in UL to assist DL scheduling.

In the solution of the present disclosure, the terminal device 110-1 may receive, from the network device 120-1, a first indication at least indicating one or more CSI-IM resources, each of the one or more CSI-IM resources being mappable to at least one SRS resource pattern. The terminal device 110 may perform, based on the first indication, at least one interference measurement associated with the one or more CSI-IM resources.

In this way, the terminal device may provide the CSI report indicating at least interference from both neighbor cell DL interference and inter-cell co-channel UE-UE CLI for CSI measurement to the network device and the network device may coordinate DL scheduling and SBFD UL scheduling between cells (i.e., the serving cell of the terminal device and its neighbor cell(s). With coordinated CSI-IM resource associated with SBFD, the terminal device can provide accurate assistance for coordinated DL scheduling and SBFD UL scheduling between cells with inter-cell co-channel UE-UE CLI.

Example embodiments of the present disclosure will be described in detail below with reference to the accompanying drawings.

Reference is now made to FIG. 3, which shows a signaling chart 300 for communication according to some example embodiments of the present disclosure. As shown in FIG. 3, the signaling chart 300 involves the terminal device 110-1 and the network device 120-1. For the purpose of discussion, reference is made to FIG. 1 to describe the signaling chart 300. It is to be understood that the process shown in FIG. 3 may also be adopted by other terminal devices and network devices shown in FIG. 1.

As discussed with reference to FIG. 1, in some scenarios, the network device 120-1 may manage a cell 102 serving the terminal device 110-1, which may be considered as the serving cell of the terminal device 110. The cell 104 managed by the network device 120-2 and cell 106 managed by the network device 120-3 may be considered as neighbor cell of the terminal device 110-1.

As shown in FIG. 3, the terminal device 110-1 may receive (305), from a network device 120-1, a first indication at least indicating one or more CSI-IM resources. Each of the one or more CSI-IM resources is mappable to at least one SRS resource pattern. For example, an SRS resource pattern may be referred to as an SRS RE pattern.

For example, the one or more CSI-IM resources may be mapped to a subband or wideband, or a number or physical resource blocks. The subband may comprise a subband configured with SBFD, e.g., an SBFD DL subband.

In some embodiments, the CSI-IM resource(s) associated with SBFD can be mapped to any SRS symbols. As an option, the CSI-IM resource(s) associated with SBFD can be any SRS pattern that one terminal device will transmit SRS. As another option, the CSI-IM resource(s) associated with SBFD can cover one or more than two SRS patterns. Additionally, the CSI-IM resource(s) associated with SBFD can be periodic or aperiodic.

In some embodiments, the CSI-IM resource(s) associated with SBFD configured by the network device 120-1 may be used as resources for interference measurement, e.g., CLI measurement.

In some embodiments, a candidate interfering terminal devices in corresponding neighbor cell can be configured by the network device 120-1 to transmit on SRS RE pattern for CLI measurement. Additionally, this can be aperiodic or periodic SRS transmission.

In some embodiments, multiple different interfering terminal devices (e.g., the terminal device 110-2 in cell 104 and the terminal device 110-3 in the cell 106) can be configured by the network device 120-1, to transmit SRS on different CSI-IM resources associated with SBFD, so that to measure multiple CSI with CLI from the different interfering terminal devices. While the network device 120-1 can configure multiple CSI report settings (i.e., CSI processes) associated with the SBFD with different CLI measurement.

In some embodiments, multiple CSI-IM resource(s) associated with SBFD and multiple CSI report settings associated with SBFD for CSI measurement with different CLI from neighbor cell(s) may be received by the terminal device.

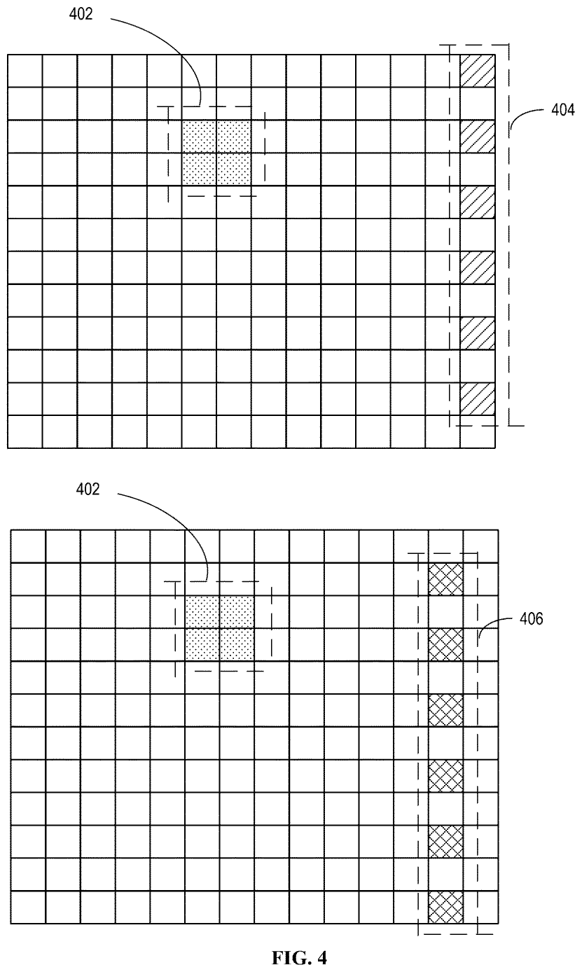

FIG. 4 shows an example of CSI-IM resource(s) associated with SBFD mapped on SRS RE pattern according to some example embodiments of the present disclosure. As shown in FIG. 4, the network device 120-1 may send CSI-RS by using the resource 402. A CSI-IM resource associated with SBFD may be mapped to a first SRS RE pattern 404 and a second SRS RE pattern 406. For example, the terminal device 110-2 in FIG. 1 may send SRS based on the first SRS RE pattern 404 to the network device 120-2 and the terminal device 110-3 in FIG. 1 may send SRS based on the first SRS RE pattern 406 to the network device 120-3.

With the mapping, when the terminal device 110-1 performs a CSI report setting for the CSI, e.g., an interference measurement based on the CSI-IM resource associated with SBFD, the terminal device 110-1 may measure the CLI, i.e., interference on terminal device 110-1 caused by the SRS transmission(s) from the terminal device 110-2 and/or the terminal device 110-3.

In some embodiments, in addition to the CSI-IM resource(s) associated with SBFD, i.e., for CLI measurement (inter-cell co-channel UE-UE CLI), the network device 120-1 may also configure normal CSI-IM resource(s) with no CLI. Correspondingly, both normal CSI report setting with normal CSI-IM resource(s) and CSI report setting with CSI-IM resource(s) associated with SBFD can be configured by the network device 120-1.

Furthermore, the network device 120-1 may transmit (310) a second indication indicating one or more CSI report settings, with each CSI report setting associated with the one or more CSI-IM for the at least one interference measurement. As one special embodiment, one CSI report setting is associated with one CSI-IM for one interference measurement. As another one special embodiment, one CSI report setting is associated with more than one CSI-IM for combination of more than one interference measurement.

Based on the one or more CSI report settings, the terminal device 110-1 may perform (315), based on the first indication, at least one measurement for the CLI in a subband associated with a duplex operation, i.e., the SBFD.

Based on the one or more CSI report settings, the terminal device 110-1 may measure interference on CSI-IM resource(s) associated with SBFD for the CLI caused by one or more transmissions in other neighbor cell(s). For example, with reference to FIG. 1, the terminal device 110-1 may perform a CSI measurement and report with, e.g., an interference measurement based on the CSI-IM resource associated with SBFD, for the CLI caused by the SRS transmission(s) from the terminal device 110-2 in the cell 104 and the terminal device 110-3 in the cell 106.

In some other embodiments, the second indication may further indicate at least one further CSI report setting associated with at least one CSI-IM resources mappable to the resources other than the at least one SRS resource pattern. That is, the interference measurement associated with at least one CSI-IM resources mappable to the resources other than the at least one SRS resource pattern may not be performed for the interference measurement with CLI. In this case, if normal CSI-IM resource(s) with no CLI is configured, the terminal device 110-1 may perform CSI report setting(s), e.g., normal interference measurement.

As shown in FIG. 3, the terminal device 110-1 may transmit (320), to the network device 120-1, a CSI report at least including a measurement result for the CLI.

In some embodiments, the terminal device 110-1 may estimate multiple CSI based on the CSI-IM resource(s) and CSI report setting(s) during the at least one interference measurement and select one or more best CSI to report to the network device 120-1.

In some embodiments, the terminal device 110-1 can be configured with multiple CSI report setting associated with SBFD from the network device 120-1. for CSI report with different CLI from neighbor cell(s).

For example, the terminal device 110-1 may receive network configured CSI report associated to the CSI report setting associated with SBFD, which may include exact CLI from special terminal device in neighbor cell.

In some embodiments, the terminal device 110-1 can be configured with two types of CSI report setting, with one type being normal CSI report setting mainly for cases with DL interference, while another type being CSI report setting associated with SBFD for cases with CLI from the neighbor cell(s). The result on both normal CSI report setting and CSI report setting associated with SBFD may be included in the CSI report.

In some embodiments, aperiodic or periodic reporting may be configured to the terminal device 110-1.

After receiving the CSI report, as shown in FIG. 3, the network device 120-1 may perform (325) network scheduling based on the CSI report related to CSI report setting associated with SBFD received from the terminal device 110-1. For example, the network device 120-1 may coordinate, with the network device 120-2 and/or 120-3, a mapping between the one or more CSI-IM resources and respective at least one SRS resource pattern, or the one or more CSI report setting indicating the mapping.

In some embodiments, coordinated scheduling can be done between serving cells, where the network device 120-1 can schedule the terminal device 110-1's PDSCH with the corresponding neighbor cell CLI from the exact terminal device (i.e., terminal device(s) 110-2 and/or 110-3), based on the corresponding CSI representing the CSI with the exact CLI taken into account, reported from the terminal device 110-1.

As discussed above, in the solution of the present disclosure, the terminal device only measures and reports for CSI with CLI from UL in neighbor cell(s). Specifically, the terminal device receives network configured one or multiple CSI-IM mapping on SRS REs and corresponding one or multiple CSI-process. Then the terminal device measures interference with CLI in SBFD subband and calculates CSI for the CSI-process. After that, the terminal device reports CSI corresponding to CSI-process to the network device. At last, the network device will do a coordinated schedule from the network side based on CSI corresponding to CSI-process reported from the terminal device.

In some embodiments, the terminal device measures and reports for CSI with CLI from UL in neighbor cell(s) and for CSI without CLI. Specifically, the terminal device receives network configured one or multiple CSI-IM resource(s) associated with SBFD mapping on SRS REs and corresponding one or multiple CSI-process and the terminal device also receives network configured normal CSI-IM on CSI-RS REs and corresponding CSI report setting.

Then the terminal device measures interference with CLI in SBFD subband and calculates CSI for the CSI-process, and the terminal device measures interference on normal CSI-IM and calculates CSI for the normal CSI report setting. After that, the terminal device reports CSI corresponding to CSI-process duplex and CSI corresponding to normal CSI report setting to network. At last, the network device may perform a coordinated schedule from the network side based on the terminal device reported CSI corresponding to CSI report and CSI corresponding to normal process without CLI.

As mentioned above, the present disclosure can be used for both SBFD and dynamic TDD, for interference measurement with CLI in the measured interference and corresponding definition for the CSI report setting. Then details on cases for SBFD are also provided, which can be similar to cases with dynamic TDD.

Additionally, there will be a new definition of CSI-IM resource(s) associated with SBFD, especially for SBFD, CSI-IM process associated with SBFD for CSI measurement and reports especially for SBFD with CLI from the neighbor cell(s). Moreover, there can be multiple CSI-IM resource(s) associated with SBFD for cases with different CLI from the neighbor cell(s) and correspondingly there are multiple CSI-IM process associated with SBFD with CSI-IM resource(s) associated with SBFD for interference measurement, while it is also possible to have the same CSI-RS but different CSI-IM resource(s) associated with SBFD for multiple CSI-IM process associated with SBFD.

With coordination between serving cells, the terminal devices may transmit SRS on different UL subband to cause different inter-terminal device CLI interference same as later experienced by terminal device for receiving PDSCH.

In addition, the terminal device may measure the CSI with inter-cell co-channel UE-UE CLI measured as interference per subband and reports to the network device.

Then network device may know the CSI with when different CLI occur and perform coordinated scheduling in SBFD related subband, for parameter selection on time/frequency resource allocation, Modulation and Coding Scheme (MCS), Precoding Matrix Indicator (PMI), Rank Indicator (RI) etc., together with the neighbor cell UL scheduling with corresponding CLI caused to the serving cell.

Furthermore, when the terminal device receive PDSCH, the interference and the SINR will be similar as the corresponding terminal device measured CSI with CLI. The measured CSI with CLI from UL in neighbor cell(s) will be helpful for coordinated scheduling and the scheduled PDSCH parameters can be aligned with the experienced interference, providing effective and accurate scheduling in cases with CLI from neighbor cell(s).

In this way, with coordinated CSI-IM resource associated with SBFD, the terminal device can measure interference from both neighbor cell DL interference and inter-cell co-channel UE-UE CLI for CSI measurement and report, providing accurate assistance for coordinated DL scheduling and SBFD UL scheduling between cells with inter-cell co-channel UE-UE CLI.

Moreover, the present disclosure can also be used for interference measurement and CSI for the case with dynamic TDD, then the CSI-IM is mapped on SRS for dynamic TDD and there is also a corresponding CSI report setting definition.

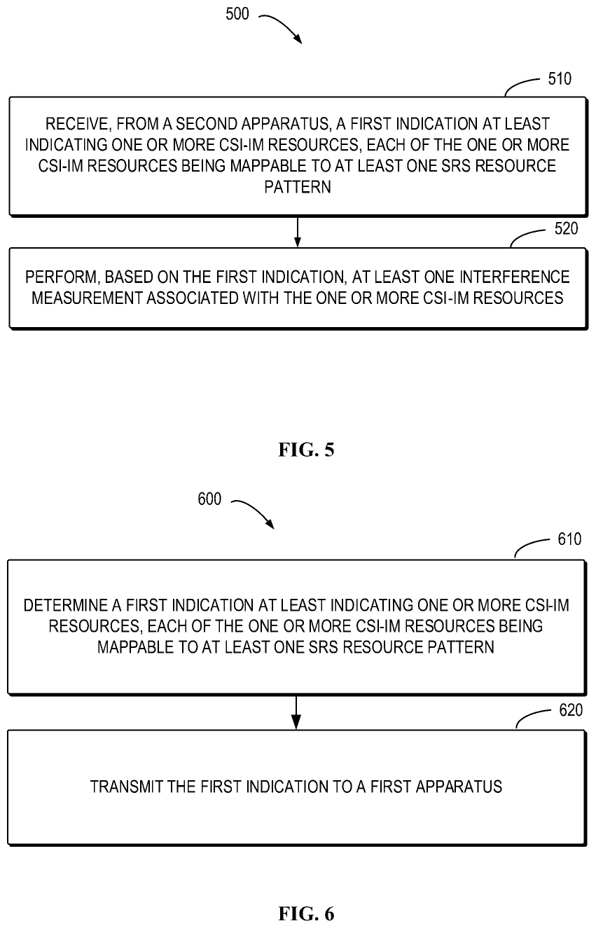

FIG. 5 shows a flowchart of an example method 500 of interference measurement for SBFD and/or dynamic TDD according to some example embodiments of the present disclosure. The method 500 may be implemented at the first apparatus (terminal device 110-1, 110-2 or 110-3) as shown in FIG. 1. For the purpose of discussion, the method 500 will be described with reference to FIG. 1.

At 510, the first apparatus receives, from a second apparatus, a first indication at least indicating one or more CSI-IM resources, each of the one or more CSI-IM resources being mappable to at least one SRS resource pattern.

At 520, the first apparatus performs, based on the first indication, at least one interference measurement associated with the one or more CSI-IM resources.

In some example embodiments, the one or more CSI-IM resources are mapped to a subband or wideband, or a number or physical resource blocks.

In some example embodiments, the subband comprises the subband configured with SBFD.

In some example embodiments, the first apparatus may receive, from the second apparatus, a second indication at least indicating one or more CSI report settings, wherein at least one of the one or more CSI report settings is associated with the one or more CSI-IM for the at least one interference measurement; estimate at least one CSI based on the one or more CSI report setting; and report the at least one CSI to the second apparatus.

In some example embodiments, a CSI-IM resource in the one or more CSI-IM resources is mapped to at least one SRS symbol or one or more SRS patterns.

In some example embodiments, a CSI-IM resource in the one or more CSI-IM resources is periodic or aperiodic.

In some example embodiments, the first indication may further indicate at least one further CSI-IM resources mappable to resources other than the at least one SRS resource pattern.

In some example embodiments, the second indication further indicates at least one further CSI report setting associated with at least one CSI-IM resources mappable to the resources other than the at least one SRS resource pattern.

In some example embodiments, the first apparatus may perform the at least one interference measurement where the interference includes cross link interference to the first apparatus.

In some example embodiments, the first apparatus may select, based on the one or more CSI report settings, the best one or more CSI from the at least one CSI; and report the best one or more CSI.

FIG. 6 shows a flowchart of an example method 600 of interference measurement for SBFD and/or dynamic TDD according to some example embodiments of the present disclosure. The method 600 may be implemented at the second apparatus (the network device 120-1, 120-2, or 120-3) as shown in FIG. 1. For the purpose of discussion, the method 600 with be described with reference to FIG. 1.

At 610, the second apparatus determines a first indication at least indicating one or more CSI-IM resources, each of the one or more CSI-IM resources being mappable to at least one SRS resource pattern.

At 620, the second apparatus transmits the first indication to a first apparatus.

In some example embodiments, the one or more CSI-IM resources are mapped to a subband or wideband, or a number or physical resource blocks.

In some example embodiments, the subband comprises the subband configured with SBFD.

In some example embodiments, the second apparatus may transmit, to the first apparatus, a second indication at least indicating one or more CSI report settings, wherein at least one of the one or more CSI report settings is associated with the one or more CSI-IM for the at least one interference measurement; and receive, from the first apparatus, at least one CSI estimated based on the one or more CSI report setting.

In some example embodiments, a CSI-IM resource in the one or more CSI-IM resources is mapped to at least one SRS symbol or one or more SRS patterns.

In some example embodiments, a CSI-IM resource in the one or more CSI-IM resources is periodic or aperiodic.

In some example embodiments, the first indication may further indicate at least one further CSI-IM resources mappable to resources other than the at least one SRS resource pattern.

In some example embodiments, the second indication further indicates at least one further CSI report setting associated with at least one CSI-IM resources mappable to the resources other than the at least one SRS resource pattern.

In some example embodiments, the at least one interference measurement is measurement of interference including cross link interference on the first apparatus.

In some example embodiments, the second apparatus may coordinate, with the one or more neighbor cells, at least one of: a mapping between the one or more CSI-IM resources and respective at least one SRS resource pattern, or the one or more CSI report setting indicating the mapping.

In some example embodiments, a first apparatus capable of performing the method 500 (for example, implemented at the terminal device 110-1, 110-2 or 110-3)) may include means for performing the respective steps of the method 500. The means may be implemented in any suitable form. For example, the means may be implemented in a circuitry or software module.

In some example embodiments, the first apparatus comprises means for receiving, from a second apparatus, a first indication at least indicating one or more CSI-IM resources, each of the one or more CSI-IM resources being mappable to at least one SRS resource pattern; means for performing, based on the first indication, at least one interference measurement associated with the one or more CSI-IM resources.

In some example embodiments, the one or more CSI-IM resources are mapped to a subband or wideband, or a number or physical resource blocks.

In some example embodiments, the subband comprises the subband configured with subband non-overlapping full duplex, SBFD.

In some example embodiments, the first apparatus comprises means for receiving, from the second apparatus, a second indication at least indicating one or more CSI report settings, wherein at least one of the one or more CSI report settings is associated with the one or more CSI-IM for the at least one interference measurement; means for estimating at least one CSI based on the one or more CSI report setting; and means for reporting the at least one CSI to the second apparatus.

In some example embodiments, a CSI-IM resource in the one or more CSI-IM resources are mapped to at least one SRS symbol.

In some example embodiments, a CSI-IM resource in the one or more CSI-IM resources are mapped to one or more SRS patterns.

In some example embodiments, a CSI-IM resource in the one or more CSI-IM resources is periodic or aperiodic.

In some example embodiments, the first indication may further indicate at least one further CSI-IM resources mappable to resources other than the at least one SRS resource pattern.

In some example embodiments, the second indication further indicates at least one further CSI report setting associated with at least one CSI-IM resources mappable to the resources other than the at least one SRS resource pattern.

In some example embodiments, the first apparatus comprises means for performing the at least one interference measurement where the interference includes cross link interference to the first apparatus.

In some example embodiments, the first apparatus comprises means for selecting, based on the one or more CSI report settings, the best one or more CSI from the at least one CSI; and means for reporting the best one or more CSI.

In some example embodiments, an apparatus capable of performing the method 600 (for example, implemented at the network device 120) may include means for performing the respective steps of the method 600. The means may be implemented in any suitable form. For example, the means may be implemented in a circuitry or software module.

In some example embodiments, the apparatus comprises means for determining a first indication at least indicating one or more CSI-IM resources, each of the one or more CSI-IM resources being mappable to at least one SRS resource pattern; and means for transmitting the first indication to a first apparatus.

In some example embodiments, the one or more CSI-IM resources are mapped to a subband or wideband, or a number or physical resource blocks.

In some example embodiments, the subband associated with the duplex operation comprises the subband configured with SBFD.

In some example embodiments, the second apparatus comprises means for transmitting, to the first apparatus, a second indication at least indicating one or more CSI report settings, wherein at least one of the one or more CSI report settings is associated with the one or more CSI-IM for the at least one interference measurement; and receiving, from the first apparatus, at least one CSI estimated based on the one or more CSI report setting.

In some example embodiments, a CSI-IM resource in the one or more CSI-IM resources are mapped to at least one SRS symbol.

In some example embodiments, a CSI-IM resource in the one or more CSI-IM resources are mapped to one or more SRS patterns.

In some example embodiments, a CSI-IM resource in the one or more CSI-IM resources is periodic or aperiodic.

In some example embodiments, the first indication may further indicate at least one further CSI-IM resources mappable to resources other than the at least one SRS resource pattern.

In some example embodiments, the second indication further indicates at least one further CSI report setting associated with at least one CSI-IM resources mappable to the resources other than the at least one SRS resource pattern.

In some example embodiments, the at least one interference measurement is measurement of interference including cross link interference on the first apparatus.

In some example embodiments, the second apparatus comprises means for coordinating, with the one or more neighbor cells, at least one of: a mapping between the one or more CSI-IM resources and respective at least one SRS resource pattern, or the one or more CSI report setting indicating the mapping.

FIG. 7 is a simplified block diagram of a device 700 that is suitable for implementing example embodiments of the present disclosure. The device 700 may be provided to implement a communication device, for example, the first terminal device 110 or the second terminal device 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 2 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

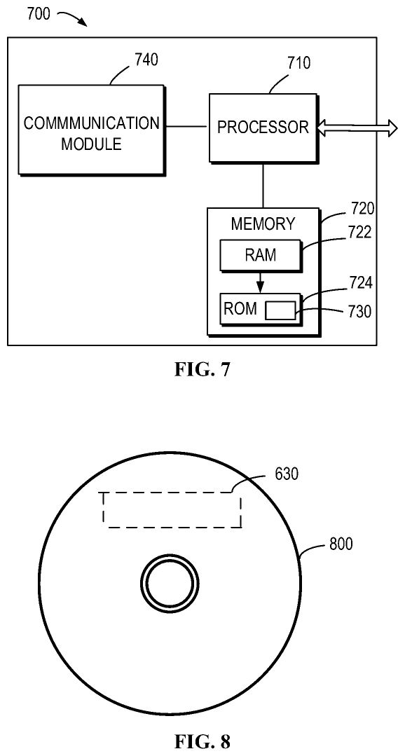

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first apparatus comprising:
at least one processor; and
at least one memory storing instructions that, when executed by the at least one processor, cause the first apparatus at least to:
receive, from a second apparatus, a first indication at least indicating one or more channel state information interference measurement, CSI-IM, resources, each of the one or more CSI-IM resources being mappable to at least one sounding reference signal, SRS, resource pattern; and
perform, based on the first indication, at least one interference measurement associated with the one or more CSI-IM resources.

2. The first apparatus of claim 1, wherein the one or more CSI-IM resources are mapped to a subband or wideband, or a number or physical resource blocks.

3. The first apparatus of claim 2, wherein the subband comprises a subband configured with subband non-overlapping full duplex, SBFD.

4. The first apparatus of any of claims 1-3, wherein the first apparatus is caused to:
receive, from the second apparatus, a second indication at least indicating one or more CSI report settings, wherein at least one of the one or more CSI report settings is associated with the one or more CSI-IM for the at least one interference measurement;
estimate CSI based on the one or more CSI report setting; and
report the CSI to the second apparatus.

5. The first apparatus of any of claims 1-4, wherein a CSI-IM resource in the one or more CSI-IM resources is mapped to at least one SRS symbol or one or more SRS patterns.

6. The first apparatus of any of claims 1-5, wherein a CSI-IM resource in the one or more CSI-IM resources is periodic or aperiodic.

7. The first apparatus of claim 4-6, wherein the first indication further indicates at least one further CSI-IM resources mappable to resources other than the at least one SRS resource pattern.

8. The first apparatus of claim 7, wherein the second indication further indicates at least one further CSI report setting associated with at least one CSI-IM resources mappable to the resources other than the at least one SRS resource pattern.

9. The first apparatus of any of claim 1 or 2, wherein the first apparatus is caused to:
perform the at least one interference measurement where the interference includes cross link interference to the first apparatus.

10. The first apparatus of claim 4, wherein the first apparatus is caused to:
select, based on the one or more CSI report settings, the best one or more CSI from the at least one CSI; and
report the best one or more CSI.

11. A second apparatus comprising:
at least one processor; and
at least one memory storing instructions that, when executed by the at least one processor, cause the second apparatus at least to:
determine a first indication at least indicating one or more channel state information interference measurement, CSI-IM, resources, each of the one or more CSI-IM resources being mappable to at least one sounding reference signal, SRS, resource pattern; and
transmit the first indication to a first apparatus.

12. The first apparatus of claim 11, wherein the one or more CSI-IM resources are mapped to a subband or wideband, or a number or physical resource blocks.

13. The second apparatus of claim 12, wherein the subband comprises a subband configured with subband non-overlapping full duplex, SBFD.

14. The second apparatus of any of claims 11-13, wherein the second apparatus is caused to:
transmit, to the first apparatus, a second indication at least indicating one or more CSI report settings, wherein at least one of the one or more CSI report settings is associated with the one or more CSI-IM for the at least one interference measurement; and
receive, from the first apparatus CSI based on the one or more CSI report setting.

15. The second apparatus of any of claims 11-14, wherein a CSI-IM resource in the one or more CSI-IM resources is mapped to at least one SRS symbol or one or more SRS patterns.

16. The second apparatus of any of claims 11-15, wherein a CSI-IM resource in the one or more CSI-IM resources is periodic or aperiodic.

17. The second apparatus of any of claims 14-16, wherein the first indication further indicates at least one further CSI-IM resources mappable to resources other than the at least one SRS resource pattern.

18. The second apparatus of claim 17, wherein the second indication further indicates at least one further CSI report setting associated with at least one CSI-IM resources mappable to the resources other than the at least one SRS resource pattern.

19. The second apparatus of any of claims 14-18, wherein the at least one interference measurement is measurement of interference including cross link interference on the first apparatus.

20. The second apparatus of claim 19, wherein the second apparatus is further caused to:
coordinate, with the one or more neighbor cells, at least one of:
a mapping between the one or more CSI-IM resources and respective at least one SRS resource pattern, or
the one or more CSI report setting indicating the mapping.

21. A method comprising:
receiving, at a first apparatus and from a second apparatus, a first indication at least indicating one or more CSI-IM resources, each of the one or more CSI-IM resources being mappable to at least one SRS resource pattern; and
performing, based on the first indication, at least one interference measurement associated with the one or more CSI-IM resources.

22. A method comprising:
determining, at a second apparatus, a first indication at least indicating one or more CSI-IM resources, each of the one or more CSI-IM resources being mappable to at least one SRS resource pattern; and
transmitting the first indication to a first apparatus.

23. A first apparatus comprising:
means for receiving, from a second apparatus, a first indication at least indicating one or more CSI-IM resources, each of the one or more CSI-IM resources being mappable to at least one SRS resource pattern; and
means for performing, based on the first indication, at least one interference measurement associated with the one or more CSI-IM resources.

24. A second apparatus comprising:
means for determining a first indication at least indicating one or more CSI-IM resources, each of the one or more CSI-IM resources being mappable to at least one SRS resource pattern; and
means for transmitting the first indication to a first apparatus.

25. A computer readable medium comprising instructions which, when executed by an apparatus, cause the apparatus to perform at least the method of claim 20, or the method of claim 21.
